(19) United States
(12) Patent Application Publication
(10) Pub. No.: US 2022/0417234 A1
(43) Pub. Date: Dec. 29, 2022

(54) HOST-INITIATED AUTHENTICATION SYSTEM AND METHOD

(71) Applicant: Anchor ID, Inc., Kingston, NY (US)

(72) Inventors: David W. Schropfer, Bearsville, NY (US); Mark Jung, Atherton, CA (US); Gerry Biundo, Lavallette, NJ (US); Carmine Nardis, Yonkers, NY (US); John R. Slack, JR., Greensboro, NC (US); Mark Roe, San Francisco, CA (US); Christopher Algozzine, Poughkeepsie, NY (US)

(21) Appl. No.: 17/362,531

(22) Filed: Jun. 29, 2021

(51) Int. Cl. H04L 29/06

(52) U.S. Cl. CPC H04L 63/083; H04L 63/0861; H04L 63/102; H04L 63/107; H04L 63/0414

(57) ABSTRACT

The invention allows an invited recipient to enter a security-protected system such as a website without traditional authentication by providing the security-protected system with a pre-arranged host-initiated authentication on behalf of the recipient. An invite message advises the recipient of the invited action, which may be as simple as entering the system or performing a task within the system. The recipient accepts the invitation by affirmatively responding to the invite message which includes the unique code to identify the recipient. Upon receipt of the affirmative response with the unique code from the recipient, the system platform executes algorithms which assess the risk of completing the action with the invited recipient, and if appropriate, provides the authentication to the security-protected system which will allow the recipient to take the invited action without providing additional authentication, such as a password.

### CROSS-REFERENCE TO RELATED APPLICATIONS

Priority is claimed on Provisional Patent Application No. 63018321, filed Apr. 30, 2020, the contents of which are incorporated herein by reference.

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

### 1. Field of the Invention

The present invention relates to a computer-implemented network communication method and system, more particularly to a computer-implemented host-initiated authentication method and system in which a message inviting a recipient to take a particular action involving a security-protected system by simply clicking on the message, without further authentication such as a passcode or other credential.

### 2. Description of Prior Art Including Information Disclosed Under 37 CFR 1.97 and 1.98

It is well known in the art for a person to send an email over the internet inviting a recipient to take a particular action, requiring the recipient to go to a particular security-protected web site, and to go through an authentication process by entering certain security codes in order to take the enter the website to take the invited action. It is also common to provide the recipient with a link to the security-protected website within a message such that the recipient can click on the link in the message which brings the recipient to the web site where the authentication process of entering the recipient's the username and passcode to allow the recipient to gain entrance to the website, in order to take the invited action. Either way, the recipient must go through an authentication process by entering a username and passcode to gain entrance to the security-protected website.

However, internet users need to enter many different security-protected web sites and must keep track of many authentication procedures including usernames and passcodes in order to do so. Further, proceeding through the authentication process each time a security-protected website is entered is tedious and time consuming.

The present invention allows a host to invite a recipient to take a particular action involving entry to a security-protected website, simply by responding affirmatively to an internet invitation message. No authentication is required from the recipient to enter the security-protected website. Further, the present invention allows the host to invite multiple recipients at the same time and to track which recipients have taken and are taking the action, and tracking any other responses from the recipient to the invited action, in real time. No need to remember passwords. No need to go through a tedious authentication process.

### BRIEF SUMMARY OF THE INVENTION

The invention allows the recipient to enter the security-protected system such as a website without authentication by providing the security-protected system with a pre-arranged host-initiated authentication on behalf of the recipient. The invite message advises the recipient of the invited action, which may be as simple as entering the system or performing a task within the system such as transferring money from a bank account within an online banking site.

The recipient accepts the invitation by responding to the invite message which includes the unique code to identify the recipient. Upon receipt of the affirmative response with the unique code from the recipient, the system platform executes algorithms which assess the risk of completing the action by the recipient, and if appropriate provides the necessary authentication process to the security-protected system on behalf of the recipient which will allow the recipient to take the invited action.

In accordance with one aspect of the present invention, a host-initiated authentication method of inviting a recipient to take a particular action is provided. The invited action involves a security-protected system accessible through a network using a host-controlled platform. The method begins with a recipient registering with host by providing at least one element of personally identifiable information. The platform receives and records the registration information. It then creates unique identifier for registered recipient. If recipient is not already registered with security-protected system, and security-protected system requires that recipient be registered for entry, the platform coordinates with security-protected system to allow the security-protected system to identify recipient.

The platform generates at least one cryptographic code associated with invited action. It prepares and sends the invite message through a network to the recipient. The message contains information referring to the cryptographic code associated with the invited action and invites the recipient to connect to the platform in order to take the invited action by sending affirmative response to message.

When the platform receives an affirmative response from the recipient with cryptographic code associated with the action and recipient's unique identifier, it generates a secure authentication code and sends a message to security-protected system through the network. The message includes the cryptographic code associated with the action and the recipient's unique identifier.

Security-protected system receives secure authentication code, the cryptographic code associated with invited action and the recipient's unique identifier; and automatically allows recipient to enter security-protected system to take invited action.

The personally identifiable information provided by the recipient includes at least one of the recipient's email address and recipient's mobile telephone number. The security-protected system may be or may include a security-protected website. The network would be the internet in many cases but does not exclude other forms of communication. The unique identifier may be dynamically generated by platform and may be represented as a ‘one-time use’ code generated by the platform. The platform can be programmed to repeat the method steps multiple times to invite additional registered recipients to take same action. It can be programmed to automatically repeat the method steps multiple times to invite additional registered recipients to take same action. The platform can track and record the recipients that have responded. It can also track the recipients that have responded affirmatively and have taken the invited action. The platform can automatically repeat the method steps multiple times to inviting the recipient until platform receives response from the recipient. It can also allow the host to manually repeat the method steps multiple times inviting the recipient until platform receives response from the recipient

The steps of the method are executed by a first algorithm which assesses the level of risk associated with completing the invited action with the recipient. The assessed risk level determines which additional algorithm(s) will be used to complete the event. The first algorithm utilizes information from the recipient's device to assess the risk including one or more of the following: the IP address of the recipient, the time of day, the server the recipient used to respond, information about the physical device that recipient is utilizing to perform invited action and the nature of the invited action.

A second algorithm is selected based upon the assessed risk to complete the operation of allowing the recipient to enter the security-protected system without additional authentication. The second algorithm may use biometric authentication, verification of recipient's location, a manually entered code by recipient, the answer by the recipient to a host-generated security question, or other security checks and/or other question/response actions.

In accordance with another aspect of the present invention, a host-initiated authentication system is provided. The system is capable of inviting a recipient to take a particular action involving a security-protected system. It employs a host-controlled, network-connected platform including a memory storing personally identifiable information for registered recipients and a secure authentication code including information used to establish an integration between the platform and the security-protected system. The platform creates and stores a unique identifier for each registered recipient.

The platform is adapted to create and send an invite message to the recipient through the network. The invite message contains a cryptographic code associated with the invited action. The message invites the recipient to connect to the security-protected system to take the invited action by sending the platform an affirmative response to the invite message.

Upon receipt of recipient's affirmative response, the platform sends the secure authentication code and the cryptographic code to the security-protected system. Upon receipt of the authentication code and the cryptographic code, the security-protected system allows the recipient to enter the security-protected system.

The personally identifiable information provided by the recipient includes the recipient's email address and recipient's mobile telephone number. The security-protected system may be a website. The network may be the internet, although other forms of communication may be employed.

The unique identifier may be dynamically generated by the platform or may be represented as a ‘one-time use’ code generated by the platform.

The platform may create and send invite messages to additional registered recipients to take the same action at the same time. The platform is capable of tracking which recipients have responded affirmatively, recipients that have declined, recipients that have not responded, recipients that have responded with a short message, and recipients that initially responded affirmatively, then later declined.

The platform can automatically and repeatedly create and send invite messages multiple times to invite the recipient until the platform receives response from that recipient. The platform can manually create and send invite messages multiple times to invite the recipient or a group of recipients upon host's command.

The platform employs a first algorithm to assess the level of risk completing the invited action. The assessed risk level determines which additional algorithm will be selected to complete the invited action.

To determine the risk level, the first algorithm utilizes information including one or more of the following: the IP address of the recipient, the time of day, the server the recipient used to respond, information about the physical device that a recipient is utilizing for the action and the nature of the invited action.

The platform employs a second algorithm to cause the security-protected system to allow the recipient to take the invited action without providing additional authentication. The algorithm itself may require biometric authentication, verification of the recipient's location, a manually entered code by the recipient, the answer by recipient to a platform-generated security question, and/or other security checks.

In order to complete the operation of allowing the recipient to enter the security-protected system without additional authentication, the platform may require at least one of the following: biometric authentication and verification of recipient's location, other question/response actions.

### BRIEF DESCRIPTION OF THE SEVERAL VIEWS OF DRAWINGS

To these and to such other objects that may hereinafter appear, the present invention relates to a host-initiated authentication method and system as described in detail in the following specification and recited in the annexed claims, taken together with the accompanying drawings in which:

FIG. 1 is a flow chart illustrating the steps in a first algorithm which performs the recipient registration;

FIG. 2 is a flow chart illustrating the steps of an exemplary second algorithm which assesses the risk level and, if appropriate, allows a recipient that has responded affirmatively to the invite message to enter the security-protected system without additional authentication;

FIG. 3 is a diagram showing how a host can invite a recipient to take an invited action;

FIG. 4 is a diagram showing that system can execute algorithm 2 to assess risk level of the action and decide if additional security measures are necessary;

FIG. 5 is a diagram illustrating an example of mobile phone access;

FIG. 6 is a diagram illustrating that an invited recipient can take the invited action on a device other than the device used to receive the invitation;

FIG. 7 is a diagram illustrating that only selected registered recipients can receive invite messages; and that invite message can be sent to an unlimited number of recipients;

FIG. 8 is a diagram illustrating that invite messages can be sent to an unlimited number of recipients; and

FIG. 9 is a diagram illustrating the appearance of an invite message on the recipient's smartphone, including the choices for response and how the platform reacts to the choices.

### DETAILED DESCRIPTION OF THE INVENTION

The invention is a process by which a person (a host) can become a central authority to actively request a person, or group of people with no size limitation, accept a digital request simultaneously and in real time. For example, a professor using this invention can simultaneously invite and admit 100 students to a group videoconference without needing to send usernames, passwords, or complicated instructions to the students. For the purpose of this document, this is referred to as “Host-Initiated Authentication”.

Through a series of communicated code and messages between two or more computer devices, a process can be executed that will allow a host to actively send a notification to one or more other smartphone, laptop, or other internet-enabled computer users (recipients) to perform, and the notification, with the permission and consent of the recipient, could contain all necessary information to execute an action, or a series of actions. This can be accomplished without ever divulging to the recipient any access codes or passwords needed to perform the action, which creates heightened security (longer passwords and/or cryptographic keys, are possible, and the password cannot be shared) plus heightened convenience for the recipient (no instructions to follow—just tap the notification that appears on the recipient's computer screen. In addition, one invite can request that the recipient's device perform an array of other functions, such as launching and logging in to multiple apps, punching a virtual timecard, and even return data about the phone (such as location) in real time—all with the permission and consent of the recipient.

Generally, the host will access a platform through a remote computer device, such as a laptop, desktop, tablet, or mobile device. This host-controlled platform can be hosted either in local, on premises servers, or the platform can be hosted on a server accessible through the internet or other network. In any case, the host's device serves only as an access point to manage the servers of the platform.

The platform servers can take multiple types of commands: including database changes, and activity changes. Database changes could include multiple types of inputs and functions, including but not limited to; adding contact information to group lists to be used as invitees for future meetings; scheduling the time and date of future meetings; deciding which attendees, or attendee groups, will be scheduled, and recording all recipient responses or lack of response.

In addition, activities can be performed using the host-controlled platform servers in several different ways, including pushing (or electronically sending) a notification to the communication device of each invited recipient with embedded information about the invited action, such as identifiers for the video conference application, username of the action, password for the action, other credentials for a given action. This element of the invention can be used for single actions or multiple actions—all executable from an affirmative response to a notification on a recipient's communication device such as a computer or mobile smartphone.

When the invitee receives the notification, tapping the notification execute commands within the notification such as, but not limited to a selection of security checks to perform on the device; whether not to execute OEM biometric check within the device; whether or not to ask the operating system of the device to scan the recipients fingerprint interface ID depending on the available equipment on the device; etc.

Examples of the use of this application include but are not limited to a teacher inviting multiple students as invitees to video conference, a sales manager inviting multiple salespeople to a sales meeting via videoconference, or a contractor dispatcher directing a fleet of plumbers to open a specific application at a specific time to start their shift.

When a host begins the video conference, a notification will be sent to each one of the phones of the invitees. Whether the notification is commanding a device to open one, or multiple, apps, all login credentials can also be included in the notification. Intentionally, the recipient does not need to read or have visibility to these additional commands.

The “human readable” information on the notification (For example, “Your 9 AM English literature class is about to begin. Click this notification to join video conference”) does not need to include any information regarding the meeting, or the password (or other credentials) to enter the meeting. Specifically, if the host does not wish to give the invitees the right or the ability to share the meeting credentials, this feature of hiding authorized invitees from intentionally or unintentionally sharing any of the meeting credentials with others is a feature that will help limit unauthorized attendees in videoconferences.

The phenomenon commonly referred to as “Zoom bombing” is an act that typically bypasses videoconference security features such as username and password. This process is typically executed by an authorized invitee who maliciously, or unknowingly, shares meeting credentials with others who intend to join the meeting without authorization, or for the purpose of learning the contents of the meeting, or to intentionally perform harmful acts such as inappropriate language or posting inappropriate images. The function of hiding the username and password in the previous paragraph removes the ability for an authorized invitee to share any information about the meeting with others because the credentials are never exposed to the invitee.

Another example of this invention is a plumbing company with multiple plumbers making house calls. Many apps exist in the marketplace today that require a contractor, like a plumber, to open an app before their shift that will allow the employer to track the plumber's location throughout the day to ensure that the plumber is moving efficiently from location to location, and from job to job.

Unfortunately, no application can prevent a user from closing it, which means that field personnel, such as plumbers, can fail to open an app that (a) enables the contractor to do their job, and (b) allows the company to track the contractors work, movements, progress, and timing throughout the day. This failure can be either accidental or intentional.

With the functions of the present invention, a dispatcher can notify to each plumber at a specific time of day, such as the time that the shift for each plumber about to begin. With one tap on their smart phone to accept the notification, and another tap to perform a Biometric check (such as face ID, or Touch ID) the plumber's acceptance of the notification can use the processes in this invention to log into that application and perform an initial function such as logging in to the apps and timeclock the plumber needs to begin work for the day.

There are many other examples of practical uses of this type of host initiating or control of a workforce to begin their workday based on a notification to their smartphones. Another example is a company that manages one or more traveling salesman, work at home call center employees, or other work-at-home jobs that require the use of a timeclock, or a set of applications to do their job. In each of these examples, a host can send a notification to each employee at pre-set time and date, to force a subordinate recipient to make a choice between accepting the notification and opening the app (or apps) that the host is requesting them to open or refusing to do so and therefore allowing the host to see such refusal. This application can be extremely useful in managing workforces at a distance by using various third-party applications come up or functions within this application, to track the time that a recipient began working, track the time the recipient logged in to various applications, and even automatically log each recipient off of each application.

The process of inviting a person to become a recipient in the system described in this invention has several components. First, the host would use the online platform to choose a person to invite. The information for the invitee can include their name, a username, an email address, or a phone number, among other items.

In one example, the host knows only the email address of the invitee. When that recipient is invited to the host's group (for example, a professor forming a group of invitees to use as the list of videoconference attendees for a given college level course via videoconference) the host would enter the email address into the platform. Then, the platform could generate an email to send to the email address, and the email would include a link that the recipient could click.

This link would have all of the embedded information for the following steps: for the recipient to go to a dedicated screen within the invitee portal of the application, for the recipient to enter their mobile phone number (if not already known) for the recipient to receive a text message on their smartphone with an executable SMS (Short Message Service) link to tap. When the recipient taps the link in the text message of their smartphone, that link would direct the recipient's device to contact the system or platform of this invention, which would compete a set of functions that would check the device to see if the application identified in the data embedded the notification is already loaded and installed on the recipient's device. If it has, then the platform would authenticate the recipient into the group with the recipient's permission. If not, then the recipient would be automatically directed to the app store of their device and download the application of the invention on to their phones. Upon registering, the SMS link would also include information about the group to which the host has invited the recipient. This process is one of many examples of how to automatically invite a recipient to a given group, even if the recipient has not yet downloaded the application.

The process of inviting the recipient to a given meeting is a combination of functions between multiple devices and systems. First, the host would initiate the meeting by logging in to the application web portal, and using the interface to choose a time, date, list of invitees or groups, and other basic meeting parameters. Then, the application or system platform would run sever functions, including: generating an email message, generating a file such as a “.ICS” file which is commonly used in calendar or scheduling systems, and creating data entries in a database for future use.

In this example, the email would be sent to the invitee with a calendar invite in the form of text within the email, and the “.ICS” file which was generated by the system platform. Importantly, this email would have two simple messages, for example: 1) “you will receive a notification to your Internet-enabled device when the meeting is ready to begin,” and 2) “you can add the time and date of the meeting to your calendar manually or by opening the attached “.ICS” file or similar file.”

Joining a video conference or meeting using the invention can be done in two general ways: joining on the device to which the notification was sent or joining on another device such as a laptop or desktop computer. To joint from a laptop or desktop computer, the recipient first receives notification to their mobile device. Next, the recipient would tap the notification, and complete whatever authentication request is presented to the recipient from the system platform servers, such as a pin code, approval from the biometric equipment included in the device (such as a fingerprint reader or a face scanner), matching image (for example, and image of a rose is displayed on the mobile device, and the recipient is advised that the exact same image of a rose must be displayed on the laptop to ensure proper authorization).

Then, the recipient would be presented with two or more choices, including but not limited to: join the meeting on device that received the notification via web conference; join the meeting in-person (no web conference app needed); join the meeting on another device via web conference; join the meeting on more than one device; respond to the host with the reason that the recipient cannot during the meeting, respond to the host that the recipient requests to be invited again after an increment of time such as 5 minutes or 10 minutes; decline the meeting. Likewise, in the case where a “host boss” is commanding a recipient employee to open an application, login, and perform the initial function of that application (for example, the invited action could be from the owner of a plumbing company sending a notification to each of the plumber employees at the same time using the host-controlled platform. With one tap of the notification, each plumber would simultaneously complete the following action: opening a time clock app, logging in to the time clock app, and then digitally ‘punching-in’ to the time clock to start their workday).

The recipient employee can choose to start these application commands on a device other than the device that receives the notification. In such a case, the recipient employee (or the plumber in this example) would be able to launch these applications, and these sessions, via another device such as a laptop or a desktop computer.

Next, if the recipient chose to work on a device other than the device that received the notification, the system platform described herein could provide several different functions that would allow a recipient to begin the video conference, or to launch and log into the applications, that are embedded in the notification.

One such function would be for the system platform to generate an email and send the email to the address on file with this system platform. The contents of this email would simply be a link to click which would appear on the alternative device (such as a laptop or a desktop). Once that email link is clicked, the link will command the application to launch on the recipient's desktop, including but not limited to: The application of the system described herein, or the application commanded to be opened in the original notification, or the credentials used to log in to any or all of these applications, or any other function.

Another such function could be to allow the user, on the device to which the notification was sent, to choose to perform this function on another device. At that time, the mobile application described herein would simply inform the recipient to log into their web portal. Upon logging into their web portal, the recipient would have access to the contents, and embedded information and commands, that were originally sent to the recipient's mobile device.

For example: if a recipient is invited to a video conference, and the recipient receives a notification to the video conference, and the recipient is given the choice to join the videoconference on a device other than the device that received the notification, then the recipient would see a message displayed on their mobile device simply informing the recipient to go to the URL, web application, or other application and login using any authentication method allowed by the portal.

After the recipient logs in to the system on the device on which they want to perform the function or attend the meeting or video conference, the recipient would see a simple message, icon, or other displayed image that would mirror the invitation, command, or request that was originally displayed on the mobile device. The recipient can then select the invitation, or command, or request, and launch the applications or videoconference on the device that they have chosen. This would enable any recipient to accept an invitation on their mobile device.

Host-initiated authorization can be initiated by the host platform in several different ways, including:
All of the functions required to initiate a meeting, including but not limited to, scheduling the meeting, starting the meeting, inviting guests to the meeting—all of these items will be available via the web portal (presumably the larger sized screen of a laptop or desktop) or a mobile device (which has a smaller screen).
All functions required to manage a meeting, including but not limited to, sending a text message to invitees, tracking the attendance of the recipients in the meeting, sending or resending notifications to invitees who have not yet arrived in the meeting, tracking the length of time an invitee was present in the meeting before leaving the meeting, tracking the time or times the invitee in the meeting was not viewing the screen or the application used to run the meeting (for example, are recipient joins the meeting, allows the host platform to take attendance, and then switches their screen view to some other application, game, or anything else that will obscure the meeting or intended application from the recipient's view).

A general example of how video conferences are created in the digital world includes simply inviting people to attend the videoconference and showing a list of invitees that have actually joined the videoconference. Typically, this list of invitees shows two or three data points, including images that describe whether invitees' microphones are engaged or muted, whether the invitee's cameras are engaged or turned off, or whether the invitees are viewing the meeting from a mobile device or a laptop or desktop.

The present invention improves on the example stated above in several ways:
The host can easily see invitees that are not presently attended the meeting;
The host can easily see which invitees have left the meeting before the termination of the meeting, and how long they remained in the meeting before their departure period.
The host can see an easily navigable set of options which allow the host to send a second, or third, or multiple) invitations to a recipient who has not attended or left early. Or, the host can send multiple text messages to and invitee who has not attend the meeting or left early. Or, the host can send an email to the invitee who has not joined the meeting, or left early.
An invitee cannot see any information or credentials about the meeting, the application, or the specific function they are being asked to do in detail through the notification. Instead, the notification will display to the recipient an overall objective, such as “your 9 AM English literature class is about to begin.” All the functions and processes, and other communication between the system's platform would be invisible to the invitee. Instead, the recipient would only need to agree to perform the function of joining the English literature class, in this example, and all the functions and credentials involved in that act would be automatic, based on this invention.

Several elements of this invention are designed to prevent a recipient from inappropriately sharing their meeting credentials. For example, if an authorized recipient decided to join a meeting, or accept the command from a “host boss” on another device, and the recipient receives an email, or other such process that would allow the recipient to login from a secondary device, then a cryptographic key would be embedded in the notification or link that would allow such notification or link to be used only once.

That means, for example, if a student wanted to allow another person to attend a class in which they had authorization to attend, that recipient would be unable to attend once those that notification was shared with another person who attended in the place of the authorized or invited recipient. In other words, if a recipient shared credentials, or in this case an email invitation to join the meeting, the recipient would forfeit the ability to join the meeting after another person joined with the recipient's credentials.

Another possible aspect of this invention includes the ability for the system platform to request, and display, a pin number. For example, if the recipient receives a notification allowing that the recipient to join the meeting via smartphone, and the recipient decides to accept that invitation via another device, the system platform could simply display the phrase “please login to platform (or URL) on the device of your choice”. When the recipient logs into the system or application embodied in the invention via another device, or the preferred device, the recipient would be commanded to enter a pin number. This pin number would be displayed on the mobile device that originally received the invitation, and the authorized recipient would need to re-enter that pin into the mobile device to ensure only the authorized recipient entered the meeting. This would allow an extra safeguard to prevent an unauthorized person to attend the meeting or perform the function described in the notification without the knowledge or consent of the authorized user.

The invention could be used to administer exams or tests in a digital environment. For example, a host platform could send a notification from the platform to the smartphone of a recipient (or, in this example, a student) to a group, or an individual recipient to begin an exam on a specific application or post.

In this example, the application used to administer the exam, and the credentials to login to that application, would be hidden from the recipient until the moment the notification is received on that user's smartphone. In addition, the credentials may also be unreadable by the authorized recipient after the notification is accepted. This would prevent an authorized recipient from sharing or distributing the credentials to take an exam. In addition, the ability of the invention to establish a biometric print or authorization of the recipient further ensures that only the person invited is able to take the exam.

An important part of the present invention is that the algorithm employed can be considered to be multiple algorithms which can be selected and used and that the main function of an algorithm is to determine which process (also known as workflow) will be used. The reason for that is with enough time, hackers can reverse engineer most workflows of most computer systems. The intent of this invention is to have multiple (or possibly infinite) different workflows by using a series of algorithms, and routinely changing those algorithms.

First, an algorithm determines the environment. This means the algorithm consumes information such as: the IP address, the time of day, the server used to respond, information about the physical device that a user is utilizing for the transaction or event, and importantly, exactly what event is being attempted by the user (logging into a website, transferring money, inviting others to a zoom meeting, etc.)

Based on all of that information, a first algorithm determines the level of risk that the system will not be able to successfully complete the invited action for the recipient. The assessed risk level will determine which additional algorithm (the second algorithm) will be used to complete the event.

The second algorithm is tasked with completing the event. For a low-risk event, the second algorithm may simply send a notification to the mobile phone and wait for the recipient to tap a yes or no button.

For a higher risk level, the algorithm may require multiple steps: for example: biometric authentication (OEM equipment such as face ID, touch ID, Samsung Fingerprint Reader), using geolocation to determine recipient's exact geographic position (with or without a permission prompt), etc. A choice of the second algorithm can also be determined or influenced by the requirements of the host, or service provider. For example, if the host wants the recipient's location checked every time, regardless of risk level, the system platform will do that.

The algorithms discussed herein are considered two algorithms for purposes of explanation but could be a single algorithm which performs multiple functions or more than two algorithms each performing one or more functions. This structure is significant because, if a hacker figures out one of our workflows somehow, the platform may have multiple other algorithms to rely on which will maintain security.

The security of the invention is based upon a combination of: requiring the recipient/invitee to follow the security steps determined by the “second algorithm”, generating a secure cryptographic code or token to send to the security-protected system, and consuming the APIs that were used to originally establish the integration between the host-initiated authentication system platform and the platform of the security-protected system.

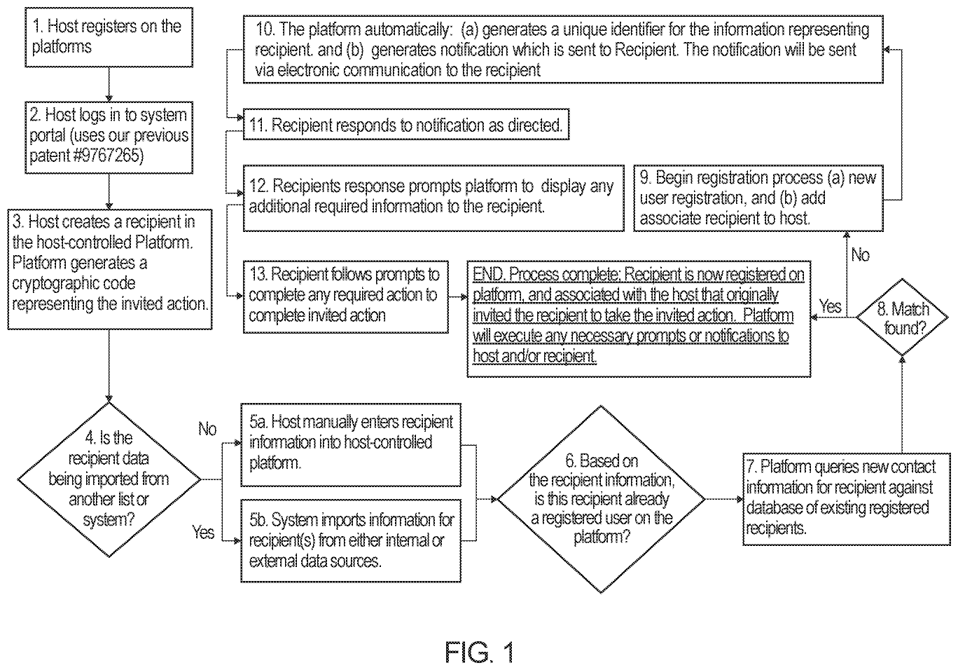

As set forth in detail on FIG. 1, the registration process for an intended recipient begins by the Host registering on the system platforms (block 1). The Host logs into the system portal using the method disclosed in U.S. Pat. No. 9,767,265 (block 2). The Host creates a recipient file in the host-controlled system platform, which generates a cryptographic code representing the invited action (block 3). A decision is made as to whether data for the recipient is to be imported from another list or system (block 4).

If the data is not being imported, the Host manually enters the data (block 5a). If the data is being imported, the system platform imports the data from either internal or external data sources.

The system platform decides if the recipient is already a registered user on the platform (block 6) by comparing newly entered data for recipient with existing registered recipients (block 7). If a match is found (block 8), the registration process is complete and associated with the host that originally invited the recipient to take the invited action, and the system platform will execute any prompts or notifications to Host and recipient (block END).

If the match is not found (block 8) registering a new user and associating the recipient to host occurs (block 9). The system platform automatically generates a unique identifier for the information representing the recipient and generates a notification which is sent as a message to the recipient through a communications network such as the internet (block 10). Upon receipt, the recipient responds to the notification as directed in the message (block 11). The response of the recipient prompts the platform to provide any additional information required to complete the registration (block 12).

The recipient follows prompts to provide information needed complete the invited action (block 13). The registration process in now complete (block END).

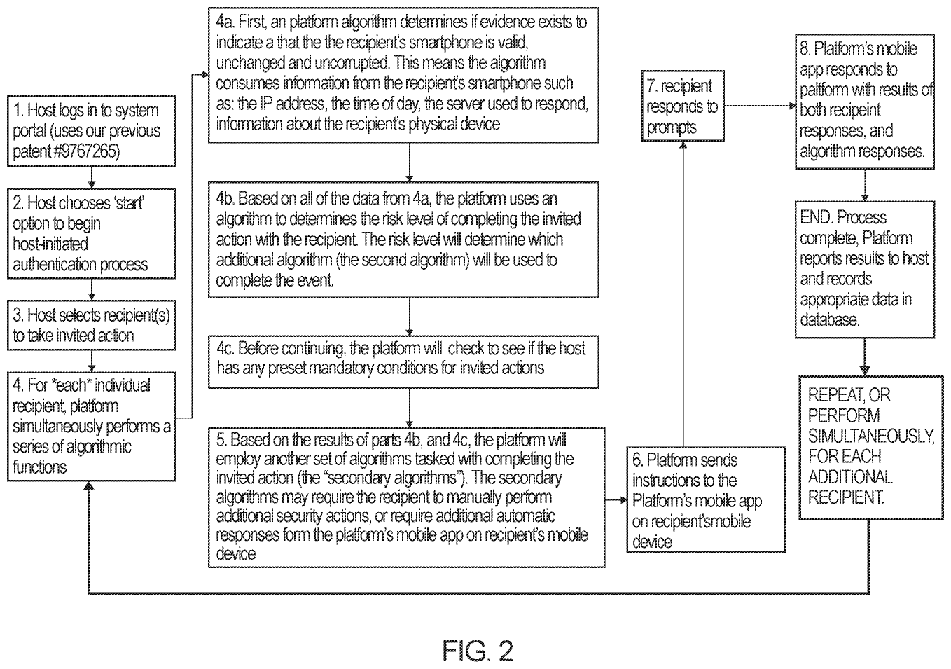

Now referring to FIG. 2 which describes the algorithms (algorithm #2) employed by the system platform to assess the level of risk involved in completing invited action with the recipient and selecting the workflow process to complete the action.

After the Host logs in to the system portal (block 1) the Host begins the host-initiated authentication process (block 2) by selecting recipient(s) to be invited to take the invited action for which host-initiated authentication will be provided (block 3).

For each individual recipient, the system platform simultaneously performs a series of algorithmic functions including risk assessment (block 4) including an algorithm by which the system platform determines if recipient's smartphone is valid using a variety of factures (block 4a). Based upon that information, the algorithm determines the risk level of completing the invited action with the recipient (block 4b). The risk level will determine which additional algorithm (the second algorithm) will be selected to complete the event. The system platform checks for any preset conditions for authorizations (block 4c) before the selection of the additional algorithm.

Based upon the assessed risk, the system platform will select another set of functions (the second algorithm) which may require the recipient to manually perform additional security checks or require additional automatic responses from the mobile app of the system on the recipient's communication device, such as a smartphone (bock 5). The system platform then sends instructions to the mobile app on the recipient's device (block 6).

The recipient responds to the prompts from the system platform (block 7) and the app responds to the system platform with results of recipient's responses and algorithm responses (block 8).

The process is now completed by the system platform reporting the results to the Host and records data in the database (block END), The process can be repeated sequentially or performed simultaneously for each additional recipient.

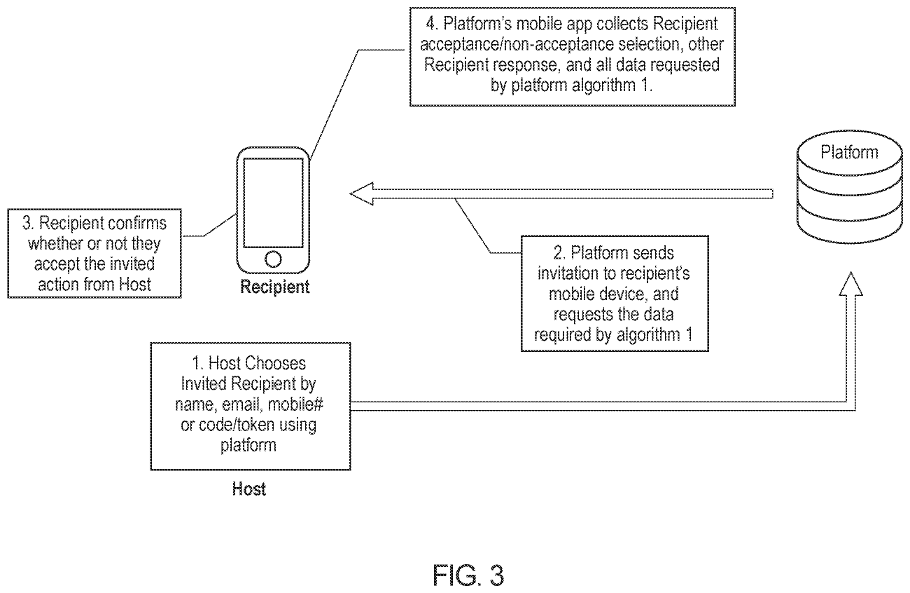

FIGS. 3 through 9 illustrate various features of the present invention. In FIG. 3, the “Host” (which is commonly a person but could be another system or instrumentality) can invite someone else (“Recipient”) to take an invited action.

To begin, the host selects the recipients to be invited to take a particular action using the platform (block 1). The platform sends an invitation message to the recipient, in this example to recipient' mobile phone) requesting data required by the first algorithm, for example inviting recipient to take a particular action (block 2). The recipient responds to message indicating whether the recipient wants to accept or decline the invitation to take the invited action. The action may be for example to enter a Zoom meeting or transfer money from an online bank account.

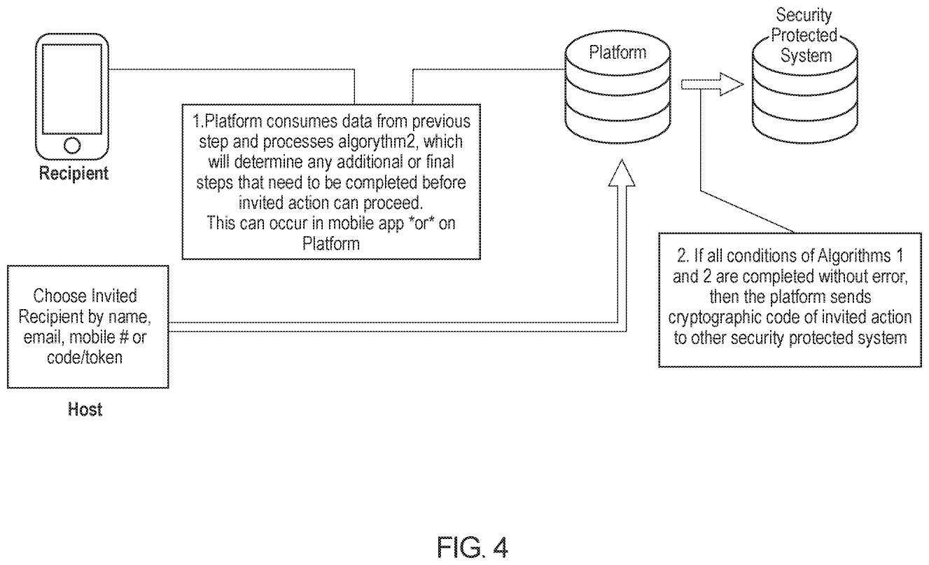

Referring now to FIG. 4, the Host selects the recipients to be invited to take the action using the system platform. After the mobile app has collected the necessary data, the system can perform algorithm 2 to determine the steps necessary to be completed before the invited action can proceed (block 1). If all conditions of algorithm 1 and algorithm 2 are completed without error, the system platform will send the cryptographic code of the invited action to the security-protected system (block 2). Algorithm 2 can be run either on the recipient's mobile app or the servers of the system platform.

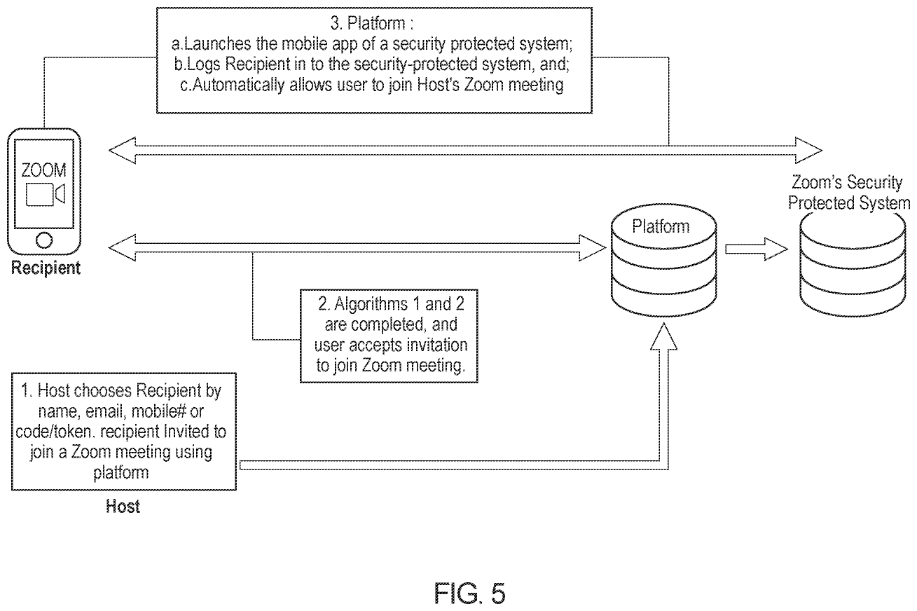

FIG. 5 illustrates an example of mobile phone access where a recipient is being invited to join a Zoom meeting (the “action”). After the Host chooses a recipient to be invited to join the Zoom meeting, and the recipient accepts the invitation, the system platform completes algorithms 1 and 2 (block 2). The platform launches the mobile app of the security-protected Zoom system, logs the recipient in to the security-protected system and automatically allows the recipient to join the host's Zoom meeting (block 3).

The invitation sent by the ‘host’ can contain commands to be executed by the recipient's smartphone, such as launching a third-party app (or any other function possible in the smartphone). These commands can also instruct the third-party app to log the user in with pre-defined credentials, and/or launch a specific meeting number, and/or automatically enter the meeting password. In this way, the host has ‘invited’ the recipient to join a meeting. Note that with this method, the invitee only accepts the invitation on their phone, and does not need to see, or know, the third-party (ex: Zoom) meeting ID, password, or other credentials.

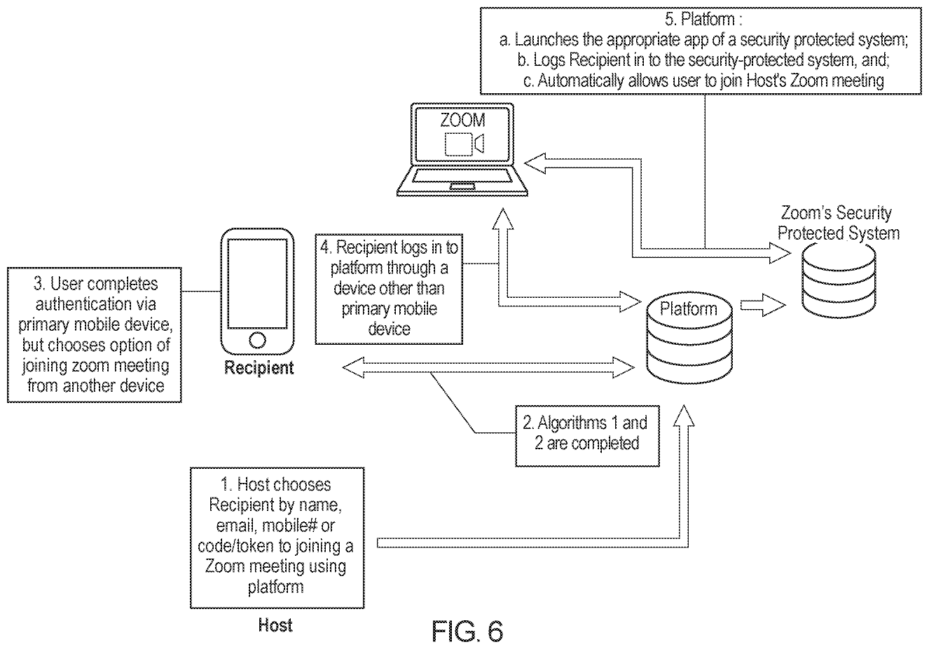

FIG. 6 illustrates an example where a device other than the recipient's smartphone is used to take the invited action, such as laptop, to join meeting. In this example, the Host selects the recipients to be invited and the system performs algorithms 1 and 2 (block 2). The platform sends the invitation to the selected recipient's smartphone. The user completes the authentication process using the recipient's mobile phone but choses to join the Zoom meeting on another device (the recipient's laptop) (block 3). The recipient logs into the platform through the other device (block 4). The platform then launches the appropriate app of the security-protected system (Zoom), logs the recipient into the security-protected system and automatically allows the recipient to join the host's Zoom meeting on the recipient's laptop computer (block 5).

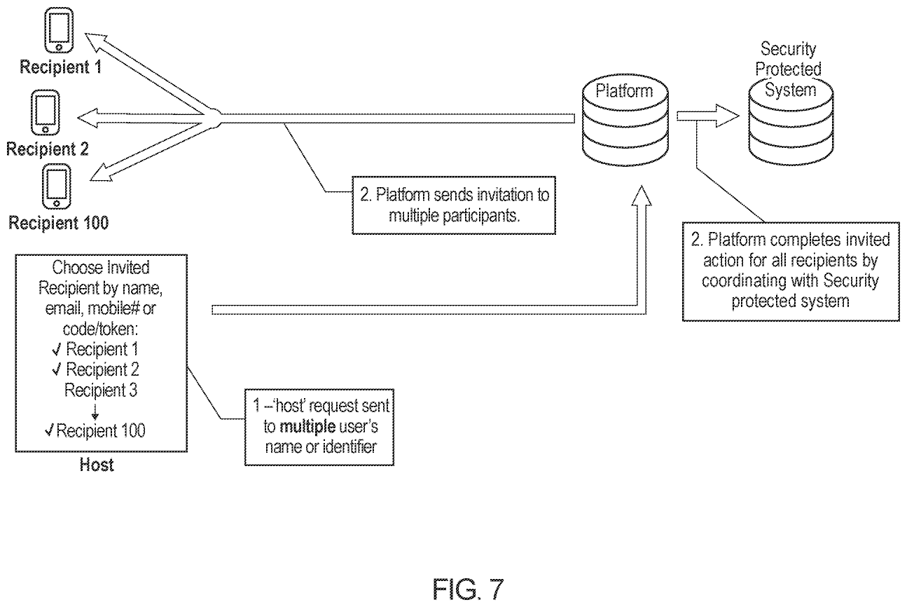

FIG. 7 illustrates that the host can choose which registered recipients are to be invited to take the action (block 1). The invitation sent by the ‘host’ can be sent to an unlimited number of people.

In this example, Recipients 1, 2, and 100 are selected. Recipient 3 has not been chosen. The platform sends the invite message to the smartphone of each of the selected recipients simultaneously or sequentially (block 2). The system platform completes the invited action for all recipients that provided affirmative replies to accept the invitation by coordinating with the security-protected system including providing the unique identifier for each recipient providing an affirmative response.

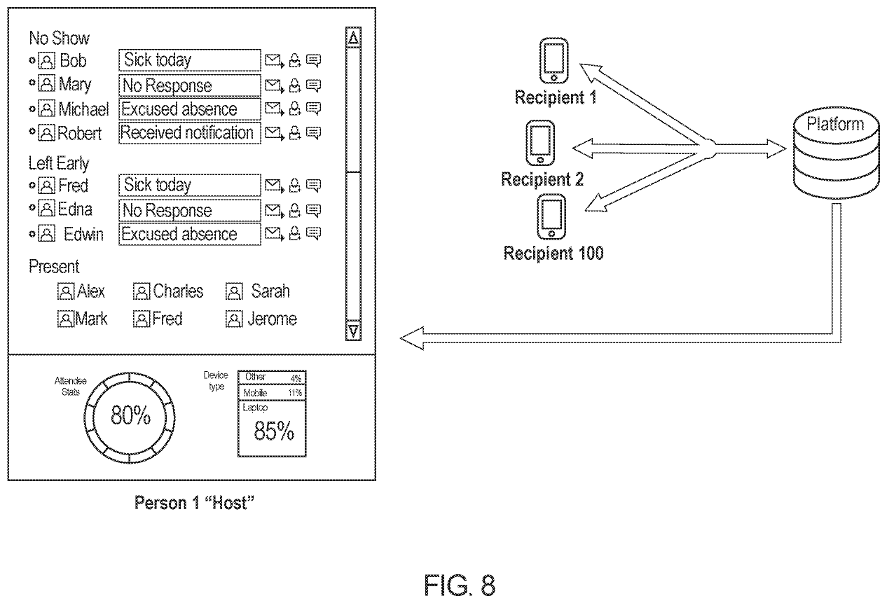

FIG. 8 illustrates that invite messages can be sent to an unlimited number of recipients and that the platform can track and store the various responses and activities of the recipients. This figure also illustrates the tools available to the host to communicate with any recipient, regardless of recipient's status (in this example: ‘No Show,’ ‘Left Early’ and ‘Present’) in real time via multiple channels (in this example: email, text message, and push notification).

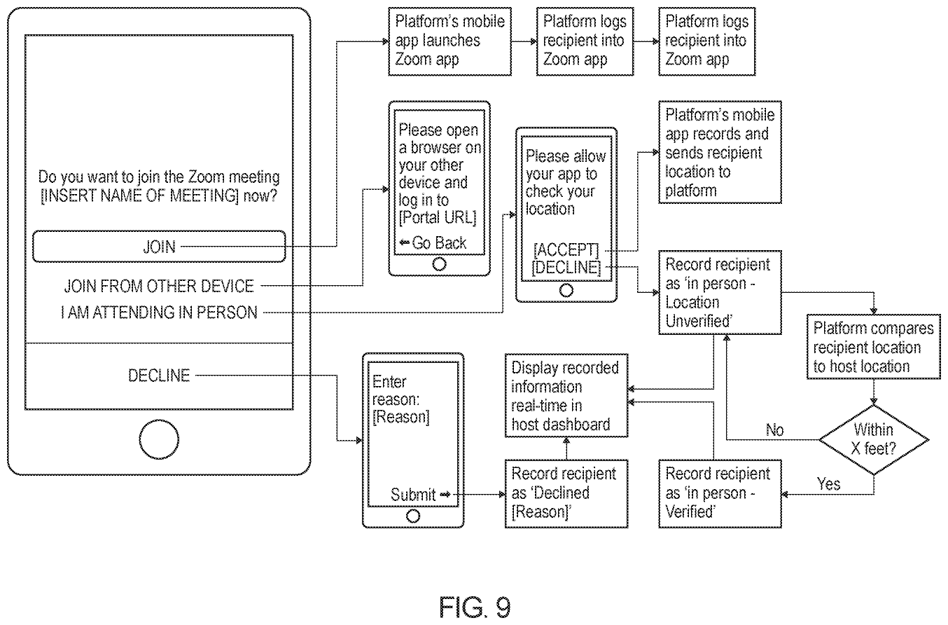

FIG. 9 illustrates the appearance of the invite message the recipient's smartphone, including the choices for response and how the platform reacts to the choices.

The responses have been described above, except in the case where the recipient is claiming to be in the same room as the host. To verify that, the platform measures the distance (in feet) between the recipient's phone and the host's phone. If the recipient and the host's phone are distance is less than “x feet” apart, where “X” is a value preset by the host or by default, then the recipient is marked ‘in-person, verified.’ If the distance between the recipient and host phones is greater than x, then the recipient is marked ‘in-person, unverified.’

The preset distance will likely be around 300 feet, given that GPS location often does not give a precise location, especially from inside a building or a classroom. In other cases, this distance may be set to 1,000 feet, or to 50 feet.

Another method that we can use here is to allow the host to enter into the platform database the exact GPS coordinates on the host's meeting room location, and then measure the distance between the recipient's phone and the meeting room location.

It will now be understood that the invention allows a recipient to enter the security-protected system such as a website without authentication by providing the security-protected system with a pre-arranged host-initiated authentication on behalf of the recipient.

An invite message is sent to the recipient advising the recipient of the action the recipient is being invited to take, which may be as simple as entering the system or performing a task within the system such as transferring money from an account within an online banking site. The recipient accepts the invitation by affirmatively responding to the invite message which includes the unique code to identify the recipient.

Upon receipt of the affirmative response with the unique code from the recipient, the system platform executes algorithms which assess the level of risk that the system will not be able to complete the invited action the recipient, and if appropriate, provides the authentication to the security-protected system which will allow the recipient to take the invited action without providing additional authentication, such as a username or password.

While only a limited number of preferred embodiments of the present invention has been disclosed for purposes of illustration, it is obvious that many modifications and variations could be made thereto. It is intended to cover all of those modifications and variations which fall within the scope of the present invention, as defined by the following claims.

We claim:

1. A host-initiated authentication method of inviting a recipient to take a particular action involving a security-protected system accessible through a network using a host-controlled platform comprising the following steps:
a. Recipient registers with host by providing at least one element of personally identifiable information;
b. Platform receives and records registration information, creates unique identifier for recipient;
c. If recipient is not already registered with security-protected system, and security-protected system may require that recipient be registered for entry, platform coordinates with system to identify recipient;
c. Platform generates at least one cryptographic code associated with invited action;
d. Platform prepares and sends message through network containing information referring to cryptographic code inviting recipient to connect to the platform in order to take the invited action by sending affirmative response to message;
e. Platform receives affirmative response from recipient with cryptographic code associated with recipient's unique identifier;
f. Platform generates a secure authentication code and sends message to security-protected system through network including cryptographic code associated with recipient's unique identifier and authentication code;
g. Security-protected system receives authentication code and cryptographic code associated with recipient's unique identifier; and
h. Security-protected system allows recipient to take invited action.

2. The method of claim 1 wherein the personally identifiable information includes at least one of the recipient's email address and recipient's mobile telephone number.

3. The method of claim 1 wherein the security-protected system comprises a website.

4. The method of claim 1 wherein the network is the internet.

5. The method of claim 1 wherein the invited action is entry into the security-protected system.

6. The method of claim 1 wherein unique identifier is dynamically generated by platform.

7. The method of claim 1 wherein unique identifier is a represented as a ‘one-time use’ code generated by the platform.

8. The method of claim 1 wherein platform repeats steps (a) thru (h) multiple times to invite additional registered recipients to take same action.

9. The method of claim 1 wherein platform automatically repeats steps (a) thru (h) multiple times to invite additional registered recipients to take same action.

10. The method of claim 1 further comprising the step of platform tracks recipients that have responded affirmatively.

11. The method of claim 10 wherein the step of tracking further comprises the step of recording which recipients have responded affirmatively.

12. The method of claim 1 further comprising the step of platform tracking recipients that have responded affirmatively and taken the invited action.

13. The method of claim 1 wherein platform automatically repeats steps (a)— (d) multiple times to invite recipient until platform receives response from recipient.

14. The method of claim 1 further comprising a first algorithm which assesses risk level.

15. The method of claim 14 wherein the assessed risk level determines which additional algorithm will be used to complete the event.

16. The method of claim 13 wherein said first algorithm utilizes information from the recipient's device to assess risk including one or more of the following: the IP address of the recipient, the time of day, the server the recipient used to respond, information about the physical device that recipient is utilizing to perform invited action and the nature of the invited action.

17. The method of claim 14 further comprising the step of using a second algorithm to complete the operation of allowing the recipient to enter the security-protected system without additional authentication.

18. The method of claim 17 wherein the step of using a second algorithm further comprises utilizing one or more of the following: biometric authentication or verification of recipient's location, other question/response actions.

19. The method of claim 17 wherein said second algorithm may require at least one of the following: biometric authentication, verification of recipient's location, a manually entered code by recipient, the answer by the recipient to a host-generated security question, and/or other security checks.

20. A host-initiated authentication network system for inviting a recipient to take a particular action involving a security-protected system comprising a host-controlled network-connected platform including a memory storing personally identifiable information and a secure authentication code including information used to establish an integration between said platform and said security-protected system; said platform being capable of creating unique identifier for recipient and sending an invite message to said recipient through the network, said invite message containing a cryptographic code associated with the invited action inviting recipient to connect to said security-protected system in order to take said invited action, by sending an affirmative response to said invite message, including said cryptographic code and said unique identifier for recipient; wherein, upon receipt of recipient's affirmative response, said platform sends said secure authentication code and said cryptographic code to said security-protected system, and wherein, upon receipt of said authentication code and said cryptographic code by said security-protected system, said security-protected system allows said recipient to take said invited action.

21. The system of claim 20 wherein said personally identifiable information includes at least one of the recipient's email address and recipient's mobile telephone number.

22. The system of claim 20 wherein the security-protected system comprises a website.

23. The system of claim 20 wherein said network is the internet.

24. The system of claim 20 wherein said action is entry into said security-protected website.

25. The system of claim 20 wherein said unique identifier is dynamically generated by platform.

26. The method of claim 20 wherein said unique identifier is represented as a ‘one-time use’ code generated by the platform.

27. The system of claim 20 wherein said platform causes said computer to create and send invite messages to additional registered recipients to take the same action.

28. The system of claim 20 wherein said host platform tracks recipients that have responded affirmatively, recipients that have declined, recipients that have not responded, and recipients that have responded with a short message, and recipients that initially responded affirmatively, then later declined.

29. The system of claim 20 wherein said computer automatically repeatedly creates and sends invite messages multiple times to invite said recipient until platform receives response from said recipient.

30. The system of claim 20 wherein said host can manually create and send invite messages multiple times to invite said recipient or a group od said recipients upon host's command.

31. The system of claim 20 wherein said platform employs a first algorithm to assess risk level.

32. The system of claim 31 wherein the assessed risk level determines which additional algorithm will be used to complete the event.

33. The system of claim 31 wherein said first algorithm utilizes information including one or more of the following: the IP address of the recipient, the time of day, the server the recipient used to respond, information about the physical device that a recipient is utilizing for the action and the nature of the invited action.

34. The system of claim 31 wherein said platform employs a second algorithm to complete the operation of allowing the recipient to enter the security-protected system without additional authentication.

35. The system of claim 31 comprising a second algorithm which may require at least one or more of the following: biometric authentication, verification of recipient's location, a manually entered code by recipient, the answer by recipient to a host platform-generated security question, and/or other security checks.

36. The system of claim 20 wherein, in order to complete the operation of allowing the recipient to enter said security-protected system without additional authentication, said platform may require at least one of the following: biometric authentication and verification of recipient's location, other question/response actions.

37. The system of claim 20 wherein said system platform can measure the distance between a recipient's communications device and the host's communication device to determine if a recipient claiming to be in within a given distance of the host actually is within said distance.
